(19) United States
(12) Patent Application Publication
(10) Pub. No.: US 2014/0115433 A1
(43) Pub. Date: Apr. 24, 2014

(54) BUSINESS MANAGEMENT SYSTEM AND METHOD

(71) Applicant: Daniel BERNERS, Sao Paulo (BR)

(72) Inventor: Daniel BERNERS, Sao Paulo (BR)

(21) Appl. No.: 14/061,137

(22) Filed: Oct. 23, 2013

(30) Foreign Application Priority Data
Oct. 23, 2012 (BR) 1020120271257

(51) Int. Cl. G06F 17/24

(52) U.S. Cl. CPC G06F 17/246
USPC 715/215; 715/212

(57) ABSTRACT

Business management system and method which uses a database and regular spreadsheets such as Excel for collecting, processing and distributing data and information using electronic forms, including display fields and data input fields, according to the access level of the user. In addition to interfaces for information input, for defining the structure and the information output the system includes a specific application for the management of information flow and interfaces, as well as the generation of synthetic graphs defined according to the user.

### FIELD

This disclosure relates to business information systems and methods used by organizations to disseminate managerial information through different hierarchical levels, for the planning and carrying out of strategic actions. It is particularly applicable to organizations with many hierarchical levels, multiple business areas or production units or markets or countries of operation, in order to enable visibility and effective communications from lower to higher levels and vice-versa.

### BACKGROUND

In general, business, educational and governmental organizations have endeavored to improve their performance, by using indicators such as productivity, financial return, satisfaction level of customers or users, among others.

The increasing competition in the business area requires companies to know their market position and to establish future goals and also the means to achieve them.

Moreover, the increasing complexity in the management of business brings greater complexity in defining actions to be taken to achieve the company's success, and greater complexity in coordinating these actions and monitoring the same.

The situation is frequently impaired by the fact that the business environment of companies often change, undermining the installation of an effective and efficient management.

Examples of this are corporate strategy, Balanced Business Scorecard, complex projects, project portfolios, economic/financial and operational performance, and issues related to innovation.

Management problems also arise, such as, for example:
the structures and processes of the organization do not favor horizontal planning;
the complexities inherent in large organizations impose limits on the effective coordination of actions;
the integration and synergy are insufficient;
there are difficulties in monitoring activities;
in most cases, the systems and processes are not flexible to change.

Consequently, tools and processes are poorly implemented or even abandoned, there is low adherence to the directives laid down by the organization leaders, loss of credibility of the management model, lack of integration between areas and actions, and lack of synergies, bringing as a frequent outcome the dismay of the teams involved.

The solutions nowadays used by the organizations are various and may be more or less sophisticated. In general, the systems and tools used are private, comprising e-mail, ERPs, integrated off-the-shelf systems, proprietary systems and tools.

Depending on the case, such systems or tools can offer a solution more or less robust to address the problems listed above.

However, the solutions adopted by companies are usually limited and restricted to specific aspects. For example, a company ERP contains a large amount of operational and financial data, while at the same company a project's management system contains information about the progress of actions.

Therefore, the methods currently used have, in general, substantial weaknesses. To portray the complexities of necessary actions in a particular area (e.g., strategic planning) no low-cost support systems are readily available which are easy to use and which accurately portray the integrated realities of the company.

Moreover, complex and costly management systems may be needed to coordinate the necessary actions. Usually, such systems are not easy to operate by users discouraging their employment, ultimately leading to their abandonment. For example, the consolidation of financial information from an ERP related to the advance of an important project usually requires that several systems must be personally validated as well as the manual production of managerial reports.

Consequently, governance and processes of large companies are often not easy to understand and follow, and the changes required by the emergence of new factors are not, as a rule, of easy and effective implementation. The same applies to support systems for information and managerial communication, which often do not have a degree of flexibility that allows its adaptation to a company's changing reality.

In general, it can be stated that each company must find a balance between two aspects: first, the organization/governance should not be too rigid or “disciplined,” because it is under the risk of failing to stimulate the full potential of its teams. On the other hand, it should not be too “loose” (decentralized, “flexible”, “ownership”), because it risks losing visibility of the actions being carried out or their control.

Secondly, systems, processes and indicators should not be too “simple” because there is the risk of complexities of the company being ignored, nor should they be too “sophisticated”, which entails the risk of low adherence by company's personnel. Relevant traits are the company's culture, IT infrastructure, systems proficiency of its members, etc.

In the absence of an effective, structured and formalized solution to meet a specific situation, the companies usually adopt an occasional and informal governance, in combination with control and management reporting by means of Excel spreadsheets. Thus, the members on all hierarchical levels now use some kind of “home-made” management solutions such as the communication by e-mail with or without attachments of MS Excel, for requesting and subsequent consolidation of data and information for various purposes and later use.

This behavior, widely seen in companies, has some advantages, such as a fast learning curve due the ease of use of Excel, a flexible storage of information and data in different ways, flexible use and low cost.

On the other hand, there are a number of shortcomings such as, for example, the difficulty of managing at larger scales, where it soon reaches the limit of its feasible use, the data being usually provided in a decentralized way, which makes their consolidation difficult, and the generalized lack of data security. Thus, such behavior usually results in a lack of consistency of data and information, in a disproportionate large team effort for gathering information, as well as need of re-workings.

Therefore, there is a need for systems that are flexible, efficient, low cost and easy to use to implement reporting tools, structured storage and sharing of managerial information and complex data of different kinds.

### SUMMARY

In view of the foregoing, this disclosure describes a business management system and a method that comprise human-machine and machine-machine interfaces to capture data and information, allowing a quick initial setting up as well as being easy to use.

In one embodiment, the interfaces are allowed to be used for integration with existing systems in specific companies.

In another embodiment, a system that allows the storage of data and information of various kinds in one centralized place in a structured way is provided, allowing the quick and easy inclusion of new data types, without recourse to a specialist for such programming.

In another embodiment, a great flexibility and ease of setting up a new set of data and information is provided, making the method and system easily applicable in a dynamic corporate environment.

In another embodiment, easy and quick inclusion of new rules and ways of processing information and data are provided.

In another embodiment, the efficiency and effectiveness of the organization as a whole, through the management of interfaces and communication means between its various areas is increased.

In another embodiment, human-machine interfaces of information and data providing and reporting is provided, that presents information and data contained in the system in a clear, easily accessible and didactic manner to the areas and persons addressed. Such presentations should reflect the inherent complexities of the company, offering a representation focused on what matters most to the area or the person addressed.

In another embodiment, a high visibility of relevant information and data of the company to a great number of recipients is provided, while preserving the confidentiality and security of information.

In another embodiment, a method is provided which is characterized by ease of use by all users, whether people who enter information and data in the system, or recipients of information and data, moreover eliminating the need for specific training to use the system, in order to provide greater adherence of the organization as a whole.

In another embodiment, the creation of a database is provided based on the formalization and systematization of the use of spreadsheets such as MS Excel, Lotus 123, OpenOffice and equivalent, for capturing, processing according to business rules and distribution of data and information.

In an embodiment MS Excel spreadsheets are used together with Java applications, with the generation of pre-defined forms, where some fields can only be seen and others may be altered, depending on the clearance level of the user.

In another embodiment, the structure of information in the database is defined through the use of spreadsheets of free definition and easy encoding, in order to facilitate insertion of new kinds of data and information in the database.

In still another embodiment, the database stores information of diverse kinds in one single place, allowing the modification of the data structure by the simple change of the forms' structure in common use spreadsheets.

Advantageously, the data capture mechanism can be set in MS Excel, so it is not necessary for the user to learn new software.

According to another embodiment, information is extracted and made available through spreadsheets, which, due to the fact that they are freely defined, facilitate the production of new forms and reports.

According to another embodiment, the spreadsheets by means of which data are inserted or made available, are updated frequently (e.g. at least daily) by the system, ensuring compatibility of data contained in the spreadsheets with data stored in the database.

According to another embodiment, the processing of information in accordance with the business rules is performed exclusively outside the system, e.g., through spreadsheets.

According to another embodiment, the interfaces are available in access places commonly employed by the user, such as a shared folder within a common network, a web page of the intranet, electronic mail and so on, eliminating the need to enter user name, password, etc.

According to another embodiment, the method of managing the spreadsheet is based in Java programmed applications.

According to yet another embodiment, the described methods and systems enables displaying complex information in innovative viewing formats, such as in an iPad, with the availability of data and information contained in the database in a sensory form, for easy communication and understanding of complex data by users, what differentiates the present invention from existing systems/software, usually limited to the provision of information in report form, in tabular or chart form, on microcomputer screen or printing mode.

### BRIEF DESCRIPTION OF THE DRAWINGS

Other features and advantages of the invention will become clearer from the description of a non-limiting embodiment, given by way of example, and of the related figures, in which:

FIG. 1 illustrates the basic elements of the system.

FIG. 2 shows a diagram of the operating logic of the system.

FIG. 3 is a simplified flowchart of the creation step of spreadsheet templates.

FIG. 4 illustrates a spreadsheet template.

FIG. 5 is a simplified flowchart of the creation step of a data structure in the database.

FIG. 6 shows an example of a filled spreadsheet.

FIG. 7 is a simplified flowchart of information output, clearance check and spreadsheet generation.

FIG. 8 shows two spreadsheets used to output the information, available in two different locations.

FIG. 9 is a simplified flowchart of viewing and data inputting in the spreadsheet.

FIG. 10 illustrates some of spreadsheets with data from the database available for updates.

FIG. 11 is a flowchart of the database updating step.

FIG. 12 is a flowchart of the step of summary chart generation by the specific application, made available for two different users.

FIG. 13 illustrates a presentation of complex information through the interfaces of the specific application—in this example, a summary chart.

FIG. 14 is a flowchart regarding the step of viewing and data inputting in interfaces of the specific application—either manually or systemically—for instance, in a summary chart.

FIG. 15 is a diagram that shows the inclusion of information into a summary chart.

FIG. 16 is a schematic representation of the database update step.

### DETAILED DESCRIPTION

For a better understanding of the present specification, a list of some words, acronyms and expressions, with their meanings is shown below:

Balanced Score Card—Set of Key Performance Indicators (KPIs) that reflect the company's adherence to its own strategy.

ERP—Enterprise Resource Planning

Spreadsheet—spreadsheet

SQL—(Structured Query Language) standard language used to interact with the most common databases on the market. The described systems and methods are not limited to the use of this language and other equivalent languages may be employed.

Dropbox—free service for storing and sharing files and documents, based on the concept of cloud computing.

File Server—Server of an organization for storing data and files, with access restricted to members of the organization.

Off-the-shelf—Software solutions ready for use—do not require customization for any specific company.

Shared drive—same as file server: server of a company, for storing data and files, with access restricted to members of the company.

SharePoint—Web application platform used in the development of corporate portals and intranets, content management, document management and development of collaborative portals.

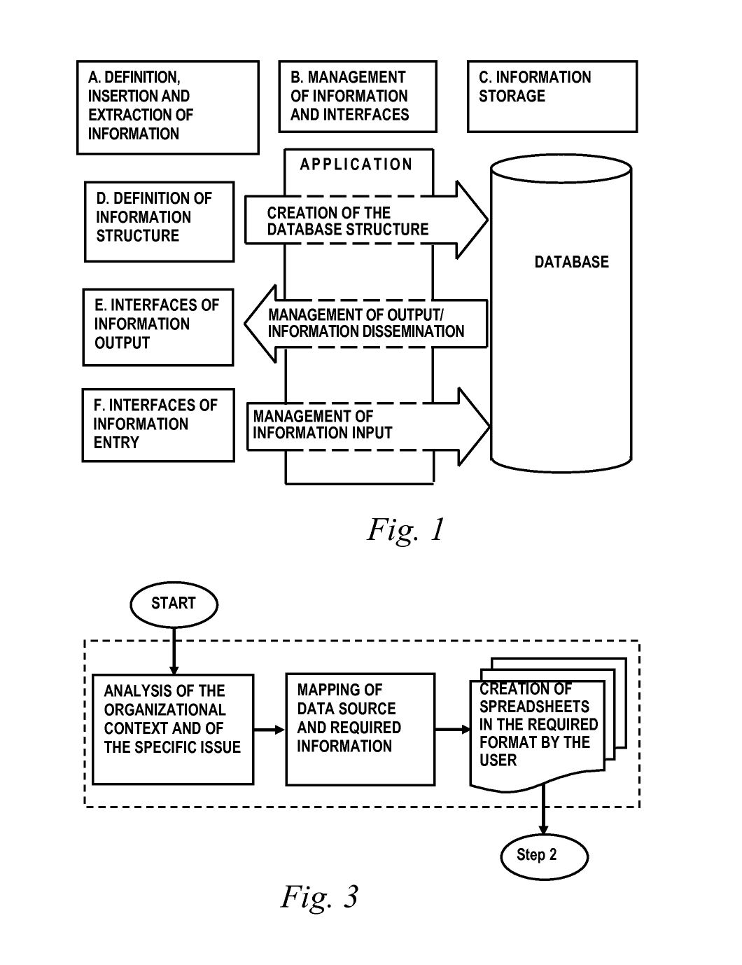

Referring now to FIG. 1, the system herein proposed comprises the following basic subsets:

A—Interfaces for defining the formats of the information input, of the information structure and of the output or information dissemination;

B—Specific application, which is the system's core, that management of information flow and interfaces, preferably programmed in Java language;

C—Databank comprising a database whose data are accessed through SQL or equivalent language, for information storage and updating.

In more detail, the subset A comprises a mechanism for defining how information is structured for insertion in the input interfaces as well as the ways in which users can access the information stored in the system.

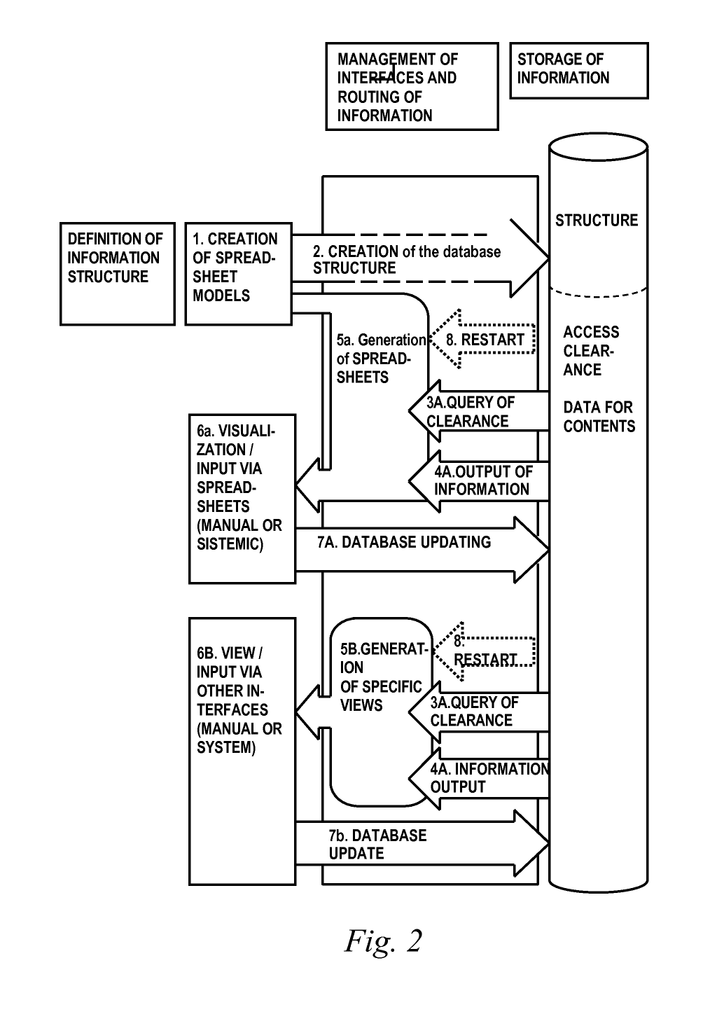

FIG. 2 shows a comprehensive view of the proposed system and the corresponding sequence of steps involved in the application of the concepts or basic objectives of the invention.

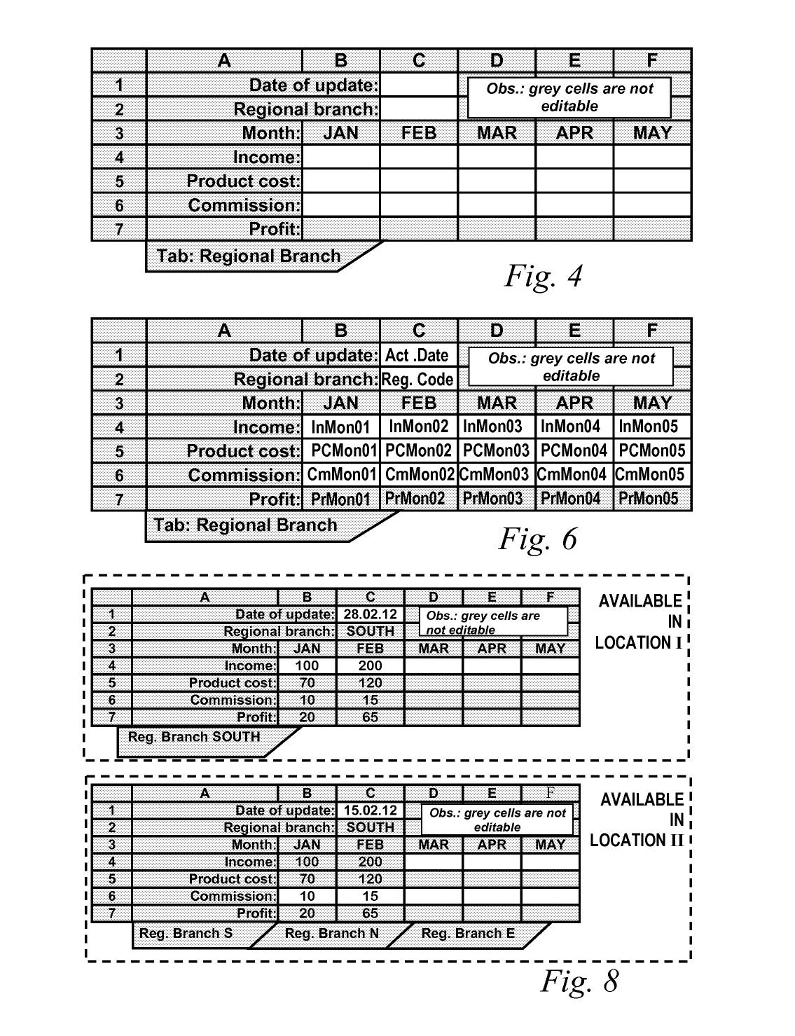

As mentioned before, in step 1 the information input is preferably performed by means of spreadsheets, according to the sequence of steps illustrated in FIG. 3. Standardized spreadsheets are used, which are configured in a “normal” way as exemplified in FIG. 4, specifying the contents of fields, such as a sequence of monthly data relating to billed amounts, costs, charges/fees, and other information of interest.

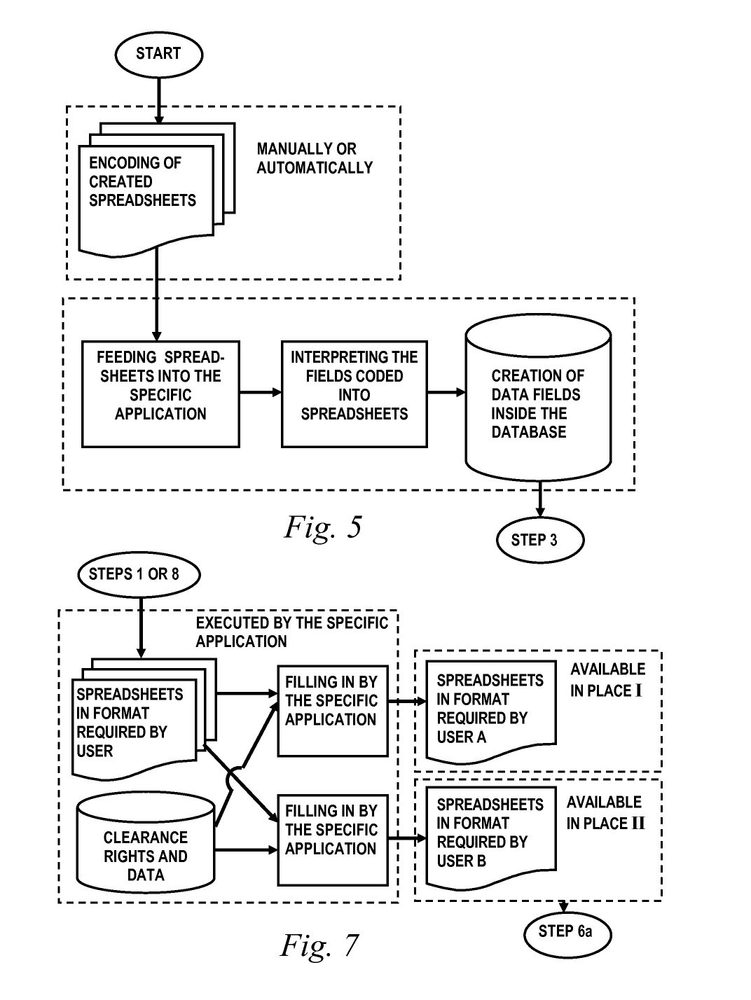

Next comes step 2, in which the information structure in the database is created, as shown in the flowchart of FIG. 5. Initially, all content fields in the spreadsheets are encoded in a particular way of the specific application, as shown by way of example in FIG. 6.

This encoding can be performed manually or automatically. After the encoding, said spreadsheets are fed into the specific application, which interprets them and creates, inside the database, fields concerning the encoded content fields.

Therefore, the structure of the database reflects the structure of the content of spreadsheets.

When a change occurs in said spreadsheets, it is loaded into the specific application whereby the structure of the database will be modified, whereas each time a new value is entered into the spreadsheet, the contents of the corresponding field in the database is accordingly updated.

Steps 3a, 4a and 5a follow, in which the user access clearance is checked, the information is brought in and the spreadsheets are generated.

Based on spreadsheets created in step 1, the specific application creates forms replicas for data inputting. These replicas are made available to users at predefined places (e.g., place “I”, place “II”, in FIG. 7)—for example, a shared drive or file server, email, dropbox, sharepoint, etc. This availability is managed by the specific application itself, i.e., what kind of spreadsheet, which data should be available in which place.

Therefore, when creating said replicas, the specific application checks the existence of relevant data for each type of spreadsheet and fills the respective data stored in the database into the specific spreadsheet in the specific place.

FIG. 8 shows specific spreadsheets for each place, the availability of the information contained in the database being related to their respective access clearances (step 3a in FIG. 2). Therefore, the specific data to the specific user are available in the specific place.

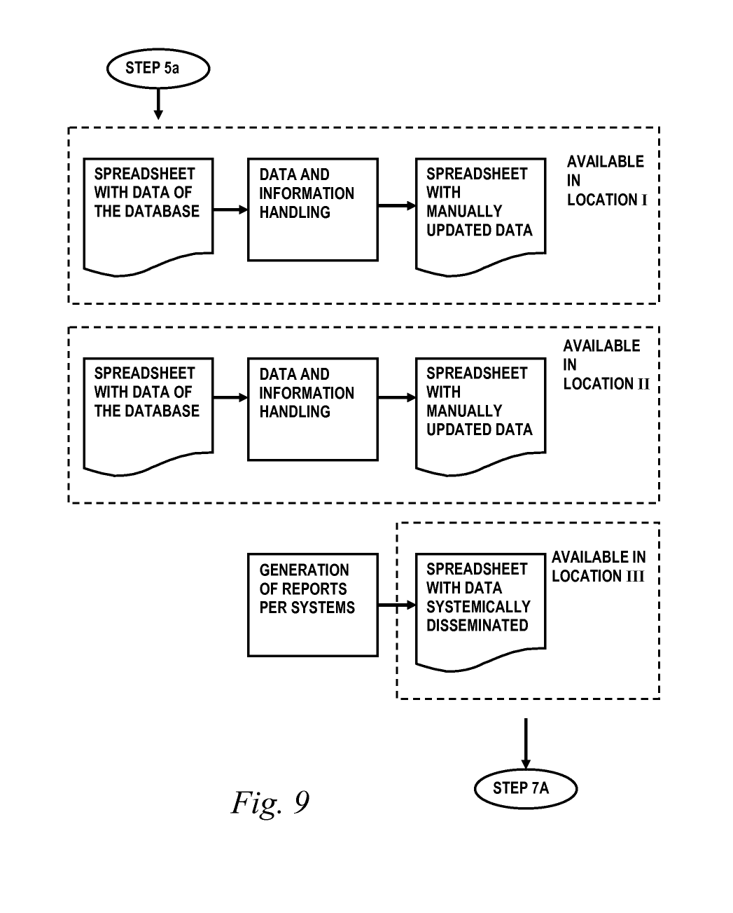

The spreadsheets with the data from the database can be accessed and viewed from specific places I, II or III as outlined in FIG. 9, and manipulated by users, according to step 6a in FIG. 2.

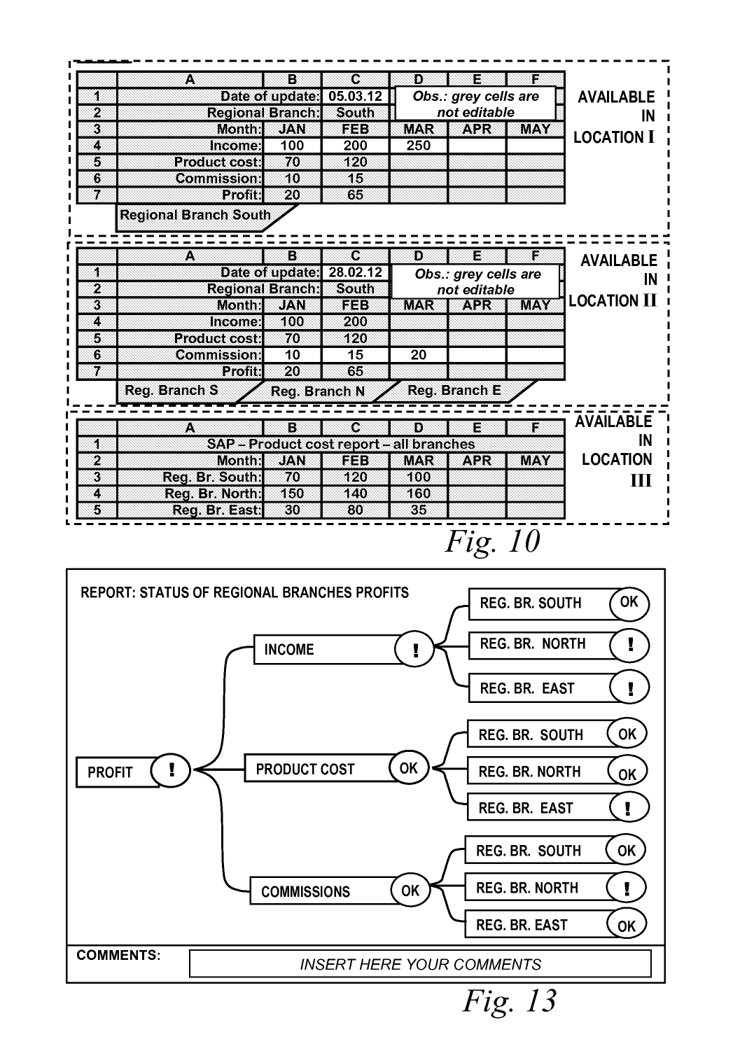

Thus, according to the example of FIG. 10, the spreadsheets provided in the places I and II may have data for the month of March manually updated to reflect a new situation of the company, the spreadsheet available at place III being systemically generated by the specific application. This latter spreadsheet is exclusively informative of the new situation, and does not contain fields destined to data inputting.

For instance, said spreadsheet may be made available to the company's board, since it allows comparing the performance of several regional branches, unlike the spreadsheets available in the places I and II, which are specific to each region.

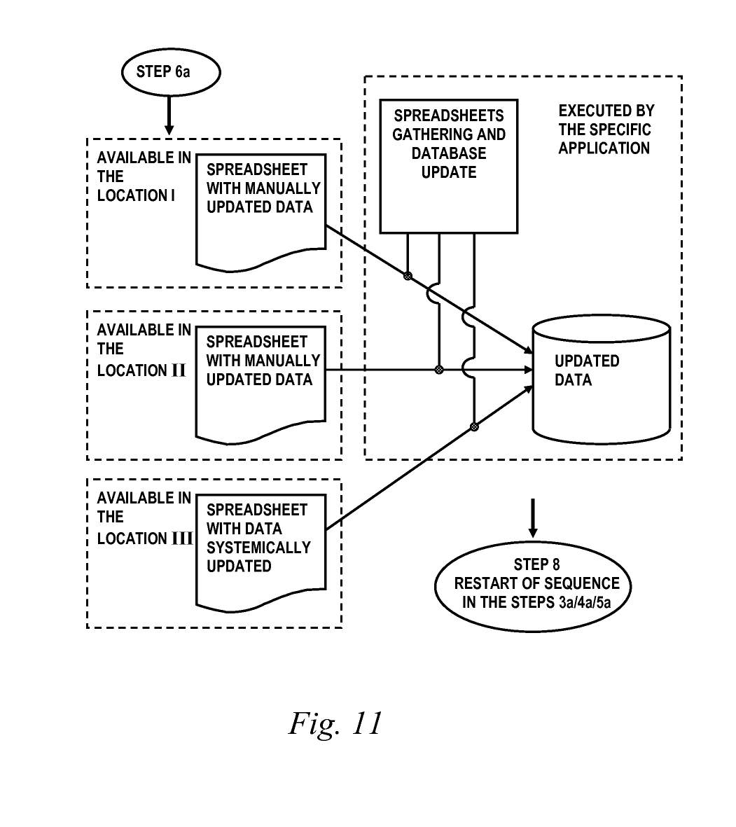

According to operation logic schematized in FIG. 2, in step 7a the spreadsheets, with data manually or systemically updated, are collected by the specific application, and data and information contained in them are fed into the database, as outlined in FIG. 11.

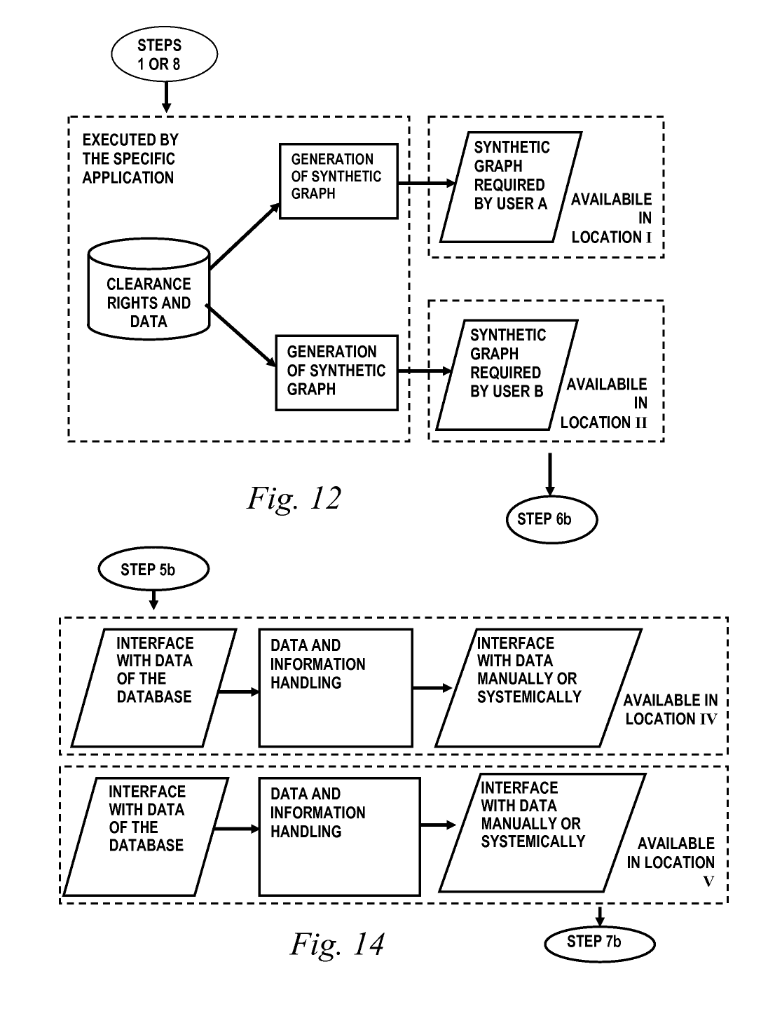

The specific application generates and makes available formats of data and information that can be used to produce summary specific charts (step 5b in FIG. 2), in which information at the macro level is displayed. Such charts may also comprise fields for appending comments or observations. The generation of such summary charts, at step 5b, is related to the step 3b (access clearance consultation), and to step 4b (information output), according to the chart shown in FIG. 2, and it is processed according to the flowchart of FIG. 12.

FIG. 13 shows a summary chart regarding the financial result of the regional branches, made available to a particular user (such as senior management), through any means including, for example, a shared drive or file server, email, dropbox, Sharepoint, iPad, smartphones, etc. This availability is managed by the specific application itself, which specifies what kind of interface and data/information should be available in which place.

When creating export files for this purpose, the specific application checks the existence of relevant data for a specific type of visualization and place availability, and inserts the corresponding respective data stored in the database into the specific places the export file.

According to the exemplary summary chart of FIG. 13, the specific application may, for example, indicate problematic branches by means of a symbol (!), or a color (red) or some other visual cue. The determination of such problems is linked to a calculation performed by the spreadsheet itself, and the result is compared with standards previously fed into the spreadsheet. The result of said comparison is stored in a specific field (which may be called “status” for instance, having contents such as “OK” or “!”). When generating the report, the specific application checks the content of this field, inserting it in the report as exemplified in FIG. 13.

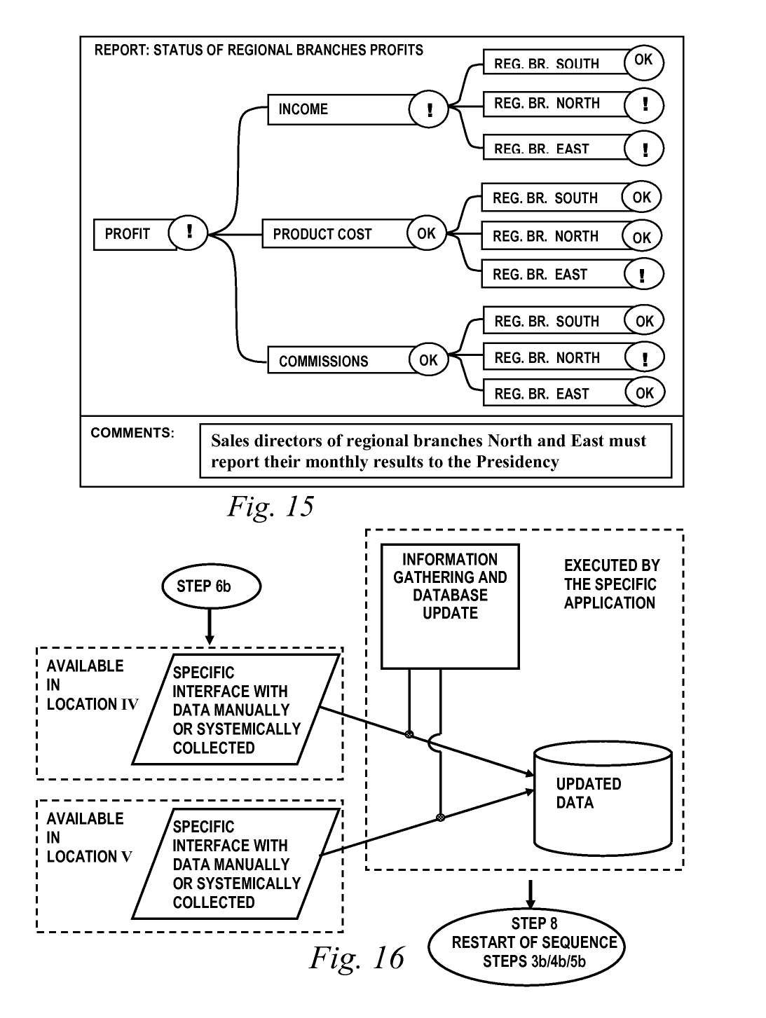

FIG. 14 is a flowchart of step 6b, shown in FIG. 2, which comprises the display and inputting of data, manually or systemically, into the interfaces of the specific application. In this presentation, relevant messages may be inserted, as indicated in the “Comments” field of FIG. 15.

The system collects the information manually or systemically updated through the interfaces of the specific application, and based on this data performs the updating of the database, as shown in the flowchart of FIG. 16, corresponding to step 7b of the logic diagram of FIG. 2.

After this update, the sequence of steps 3a/4a/5a 3b/4b/5b related to the availability, upgrading and gathering of spreadsheet and interfaces of the specific application can be restarted.

Although the invention has been described with reference to a specific embodiment, it should be understood that modifications may be introduced by those skilled in the art, without departing from the spirit and scope of the invention. Therefore, the invention is defined and limited by the claims that follow.

1. A business management system which uses a database and regular spreadsheets for collecting, processing and distributing data and information through electronic predefined forms on the spreadsheets, comprising display and data entry fields, according to the access level of the user.

2. The business management system as claimed in claim 1, wherein said system comprises the following subsets:
information input interfaces configured to define the information structure and its output or dissemination;
a specific application configured to manage the information flow and interfaces; and
a database configured to store information.

3. The business management system as claimed in claim 2, wherein said interfaces comprise MS Excel spreadsheets.

4. The business management system as claimed in claim 2, wherein said specific application is programmed in Java language.

5. The business management system as claimed in claim 2, wherein the structure of said database is created by said specific application by coding the content fields of the spreadsheets, said specific application creating fields, inside the database, corresponding to said content fields.

6. The business management system as claimed in claim 2, wherein the system is further configured to generate spreadsheets, said generation comprising the checking of a specific clearance of each user as well as checking said database.

7. The business management system as claimed in claim 6, wherein a minimum period for generating successive spreadsheets is 24 hours.

8. The business management system as claimed in claim 2, wherein the system is further configured to produce specific synthetic graphs in which the information is displayed at a macro level, said production comprising the checking of a specific clearance of each user, as well as checking the database.

9. A business management method comprising the following steps:
creating spreadsheet models in a format required by a user;
creating a data structure in a database;
creating forms for data input;
updating the database from the information inputted into said forms;
generating and providing synthetic graphs.

10. The business management method as claimed in claim 9, wherein the step of creating the spreadsheet models in the format required by the user is done by human action based on the analysis of the organizational context and the mapping of data sources and required information.

11. The business management method as claimed in claim 9, wherein the creation of the data structure comprises the coding of spreadsheets, inputting said spreadsheets into a specific application in order to interpret and create fields previously coded as well as creating data fields within the database.

12. The business management method as claimed in claim 11, wherein said database is a relational database whose information is accessed through SQL or an equivalent language.

13. The business management method as claimed in claim 9, wherein the creation of forms for inputting data comprises the acquisition of information, checking a user access clearance and providing specific forms for each user.

14. The business management method as claimed in claim 9, wherein specific fields in said forms are manually updated by the users.

15. The business management method as claimed in claim 14, wherein the manually updated forms are collected by an application and the information contained therein is inserted into said database.

16. The business management method as claimed in claim 9, wherein the step of generating and providing synthetic graphs comprises securing the information stored in said database, checking an access clearance of the user and generating specific synthetic graphs for each user.
